(19) United States
(12) Patent Application Publication
(10) Pub. No.: US 2012/0075272 A1
(43) Pub. Date: Mar. 29, 2012

(54) Display Device

(75) Inventor: Takashi Sasaki, Osaka-shi (JP)

(73) Assignee: SHARP KABUSHIKI KAISHA, Osaka-shi, Osaka (JP)

(21) Appl. No.: 13/375,013

(22) PCT Filed: Apr. 19, 2010
(86) PCT No.: PCT/JP2010/056941

§ 371 Date: Nov. 29, 2011

(30) Foreign Application Priority Data
Jun. 16, 2009 (JP) 2009-143612

(51) Int. Cl. G09G 3/36; G06F 3/038

(52) U.S. Cl. 345/204; 345/87

(57) ABSTRACT

In order to provide a display device with a light workload in repair, a liquid crystal display device includes a liquid crystal panel, a source driver for driving the display panel, a timing controller for supplying a timing control signal to the source driver, a memory storing intrinsic correction data for correcting display unevenness generated on a display screen of the display panel, and the memory is provided on a source substrate on which the source driver is provided. It is therefore unnecessary to do work, such as attachment of the memory to a new control substrate, when a repairer replaces the control substrate with new control substrate in repair of the liquid crystal display device.

### TECHNICAL FIELD

The present invention relates to a display device, such as a liquid crystal display device, and more particularly to a display device capable of reducing a workload in repair.

### BACKGROUND ART

Display unevenness generated on a display screen of a liquid crystal panel is divided into two kinds: one is generated due to design; and the other is generated due to production. Luminance unevenness, which is caused by placement of a light source of a backlight unit, is an example of the display unevenness due to design. Specifically, in a case where the light source of the backlight unit is provided at the end of a light guide plate, a screen effective display area is likely to be brighter at the end than in the center. In order to improve display quality of the liquid crystal panel, the liquid crystal display device stores common correction data for correcting the display unevenness due to design, which correction data is shared by the liquid crystal display devices of a same model as that of the display device.

Meanwhile, the display unevenness due to production is caused by, for example, slight differences in distance between an array substrate and a counter substrate of the liquid crystal panel. A position and extent of the display unevenness due to production are different among liquid crystal display devices, so that the common correction data cannot overcome the display unevenness due to production. The display unevenness due to production has caused deterioration of display quality and yield of the liquid crystal panel.

In view of the circumstances, Patent Literature 1, for example, discloses a technique for improving display quality of liquid crystal display device by storing its intrinsic correction data for correcting display unevenness due to production of the display device.

FIG. 3 is a block diagram illustrating a schematic arrangement of a liquid crystal display device 11 described in Patent Literature 1. The liquid crystal display device 11 includes a liquid crystal panel 12, a source driver 13a, a gate driver 13b, a timing controller 14, and a memory 15. The source driver 13a and the gate driver 13b drive the liquid crystal panel 12 on the basis of a timing control signal supplied from the timing controller 14. The memory 15 stores correction data for correcting inherent display unevenness generated on a display screen of the liquid crystal panel 12. The correction data is obtained by measuring display unevenness of each liquid crystal display device 11.

The liquid crystal display device 11 receives display data via a connector 16 from an image signal source such as a computer, a video, or a tuner. Then a correction signal is added to the display data in the memory 15, and the display data added with the correction signal is inputted to the timing controller 14. The timing controller 14 drives the source driver 13a and the gate driver 13b on the basis of the display data added with the correction data, and the source driver 13a and the gate driver 13b cause the liquid crystal panel 12 to display an image based on the display data. Note that luminance of a position where display unevenness is generated on the liquid crystal panel 12 is corrected by the correction data so as to have a predetermined reference luminance, because the display data is added with the correction data intrinsic (i.e., specially-made) for the liquid crystal display device 11. This makes it possible to display a desired image on the display screen of the liquid crystal panel 12 without display unevenness.

Patent Literature 1 does not disclose a position where the memory 15 is provided. However, in a commercial product, a memory for storing the correction data is provided on a control substrate including the timing controller.

FIG. 4 is a block diagram of a conventional liquid crystal display device 21 including the technique of Patent Literature 1. The liquid crystal display device 21 includes a liquid crystal panel 22, source drivers 23, a timing controller 24, and a memory 25. The source drivers 23 are provided on a source substrate 26. The timing controller 24 and the memory 25 are provided on a control substrate 27. The source substrate 26 and the control substrate 27 are connected to each other via a connector 261 of the source substrate 26 and a connector 271 of the control substrate 27. The timing controller 24 is connected to the source drivers 23 via the connectors 271 and 261, and in addition, is connected to an outside image signal source via a connector 272 of the control substrate 27.

The memory 25 stores intrinsic correction data (γ-correction data, correction data by each tone and in-plane correction data of a feed-through voltage, and the like) for correcting display unevenness which is generated on a display screen of the liquid crystal panel 22. When the display data is inputted to the timing controller. 24 from the outside image signal source, the timing controller 24 reads out the correction data stored in the memory 25 and generates corrected display data. The source drivers 23 output analog signals for tone display to source signal lines of the liquid crystal panel 22 on the basis of the corrected display data supplied from the timing controller 24.

### CITATION LIST

Patent Literature

Patent Literature 1

Japanese Patent Application Publication, Tokukaihei, No. 9-318929 A (Publication Date: Dec. 12, 1997)

### SUMMARY OF INVENTION

Technical Problem

In order for a service engineer to repair a broken liquid crystal display device on site by replacing a control substrate with a replacement control substrate, it is necessary to prepare the control substrate in accordance with a model of the liquid crystal display device so that the control substrate to be replaced and the replacement control substrate have same specs. Accordingly, a memory provided in a replacement control substrate stores a common correction data for correcting display unevenness due to design, however, does not store intrinsic correction data for correcting display unevenness due to production.

FIG. 5 is a block diagram illustrating the liquid crystal display device 21 in which the control substrate 27 has been replaced with a new control substrate 27a. A memory 25a of the control substrate 27a does not store intrinsic correction data for correcting display unevenness due to production as described above, so that contents of the correction data read out by the timing controller 24 becomes different between the control substrate 27 and the control substrate 27a. This may cause display unevenness on the liquid crystal panel 22 of the liquid crystal display device 21 after the control substrate is replaced.

It becomes necessary, when the control substrate is replaced, (i) to transfer the correction data stored in the memory 25 of the control substrate 27, which is to be replaced with a new control substrate, to the new memory 25a of the control substrate 27a or (ii) to attach the memory 25 of the control substrate 27, which is to be replaced with a new control substrate, to the new control substrate 27a. This causes a service engineer to have a heavy workload when replacing the control substrate.

The present invention has been made in view of the aforementioned problem, and an object of the present invention is to accomplish a display device with a light workload in repair.

Solution to Problem

In order to attain the aforementioned object, a display device according to the present invention includes: a display panel; a drive circuit for driving the display panel; a timing controller for supplying a timing control signal to the drive circuit; and intrinsic data storage means for storing intrinsic data that is set to the display device individually, wherein the intrinsic data storage means is provided on a section other than a control substrate on which the timing controller is provided.

According to the aforementioned arrangement, the intrinsic data storage means for storing the intrinsic data that is set to the display device individually, in other words, the intrinsic data storage means for storing data that is different one to another among the display devices is provided on the section other than the control substrate on which the timing controller is provided. Accordingly, the intrinsic data storage means is not removed from the display device when the control substrate is replaced on site in repair of a display device. That is, unlike the conventional product, it is unnecessary to do work, such as attachment of the intrinsic data storage means to a new control substrate, when a repairer replaces the control substrate.

Components other than the control substrate are rarely replaced on site, so that, even if the intrinsic data storage means is provided in any of these components, the present invention can reduce a workload of a repairer more than a conventional arrangement (i.e., the arrangement in which the intrinsic data storage means is provided on the control substrate). Accordingly, the present invention can accomplish a display device with a light workload in repair.

Advantageous Effects of Invention

A display device according to the present invention includes: a display panel; a drive circuit for driving the display panel; a timing controller for supplying a timing control signal to the drive circuit; and intrinsic data storage means for storing intrinsic data that is set to the display device individually, wherein the intrinsic data storage means is provided on a section other than a control substrate on which the timing controller is provided. Accordingly, the present invention can accomplish a display device with a light workload in repair.

### BRIEF DESCRIPTION OF DRAWINGS

FIG. 1

FIG. 1 is a block diagram illustrating an arrangement of a liquid crystal display device according to an embodiment of the present invention.

FIG. 2

FIG. 2 is a block diagram illustrating the liquid crystal display device after a control substrate is replaced.

FIG. 3

FIG. 3 is a block diagram illustrating a schematic arrangement of a conventional liquid crystal display device.

FIG. 4

FIG. 4 is a block diagram illustrating another conventional liquid crystal display device.

FIG. 5

FIG. 5 is a block diagram illustrating the another conventional liquid crystal display device after a control substrate is replaced.

### DESCRIPTION OF EMBODIMENTS

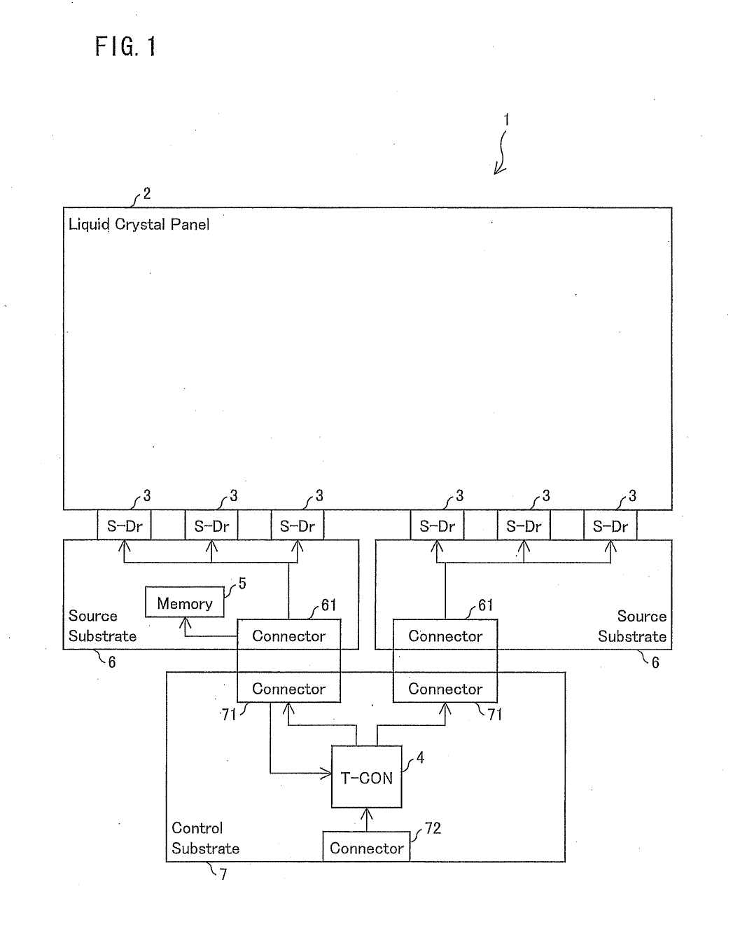

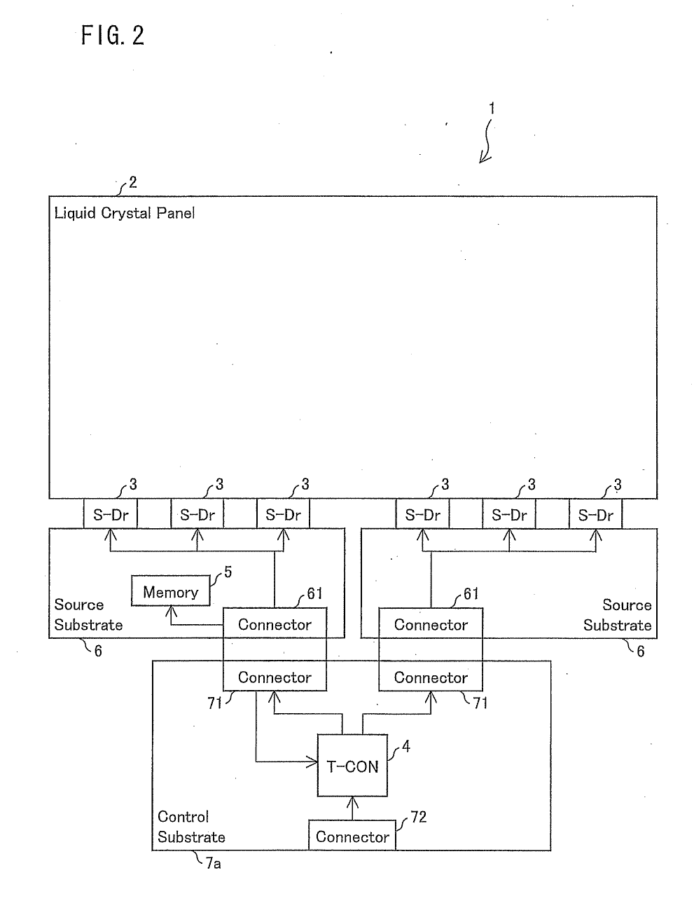

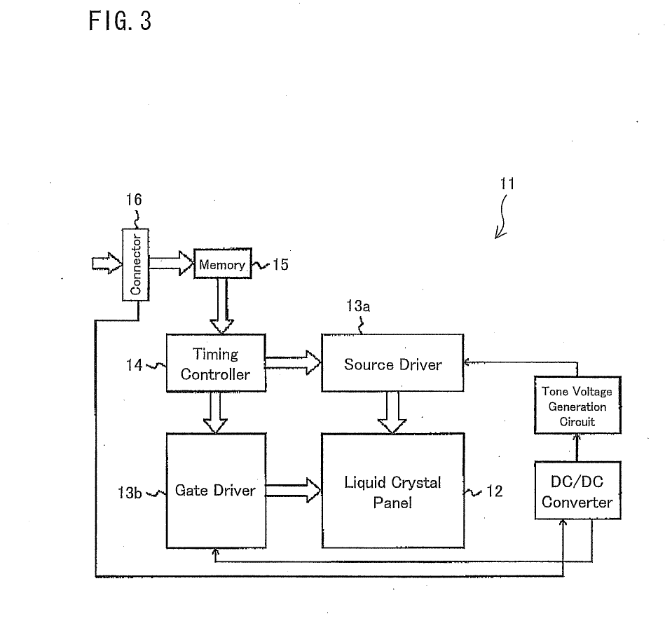

One embodiment of the present invention will be described below with reference to FIGS. 1 and 2.

FIG. 1 is a block diagram illustrating an arrangement of a liquid crystal display device 1 according to the present embodiment. The liquid crystal display device 1 includes a liquid crystal panel (display panel) 2, source drivers 3, a timing controller 4, and a memory 5. The source drivers 3 correspond to a data signal line drive circuit recited in Claims, and are provided on a source substrate 6. The timing controller 4 is a control IC for supplying timing control signals to the source drivers 3. The timing controller 4 and the memory 5 are provided on a control substrate 7. The source substrate 6 and the control substrate 7 are connected to each other via a connector 61 of the source substrate 6 and a connector 71 of the control substrate 7. The timing controller 4 is connected to the source drivers 3 via the connectors 71 and 61, and in addition, is connected to an outside image signal source via a connector 72 of the control substrate 7.

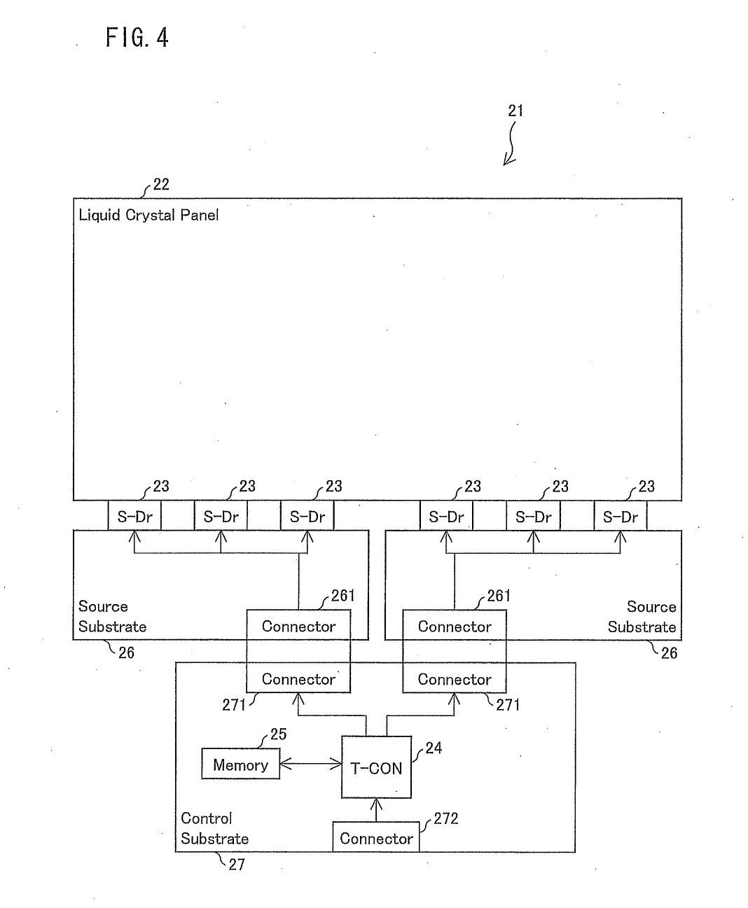

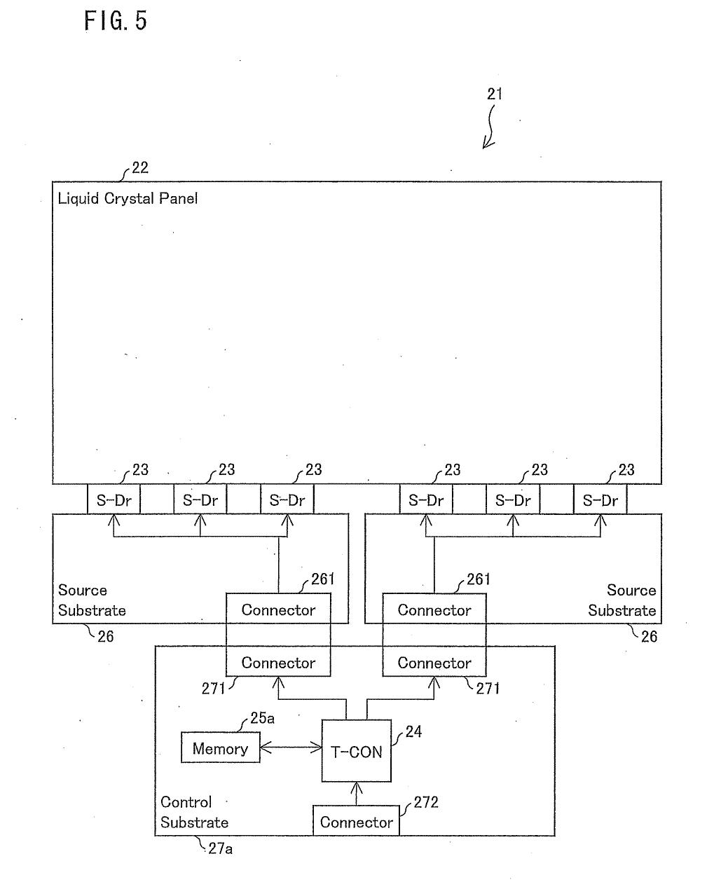

The memory 5 is a recording medium, such as a flash memory or an EEPROM, and corresponds to intrinsic data storage means recited in Claims. The memory 5 stores intrinsic correction data for correcting display unevenness generated on a display screen of the liquid crystal panel 2. The liquid crystal display device 1 is different from the conventional liquid crystal display device 21 of FIG. 4 in that the memory 5 is provided on the source substrate 6 in place of the control substrate 7.

The memory 5 is connected to the timing controller 4 via the connectors 61 and 71. The timing controller 4 has a function of correcting display data supplied from the outside image signal source. When display data is supplied, the timing controller 4 reads out correction data from the memory 5 of the source substrate 6 and generates corrected display data. The source drivers 3 generate analog signals for tone display on the basis of the corrected display data supplied from the timing controller 4, to thereby drive source signal lines (data signal lines) of the liquid crystal panel 2. This makes it possible to display an image on the display screen of the liquid crystal panel 2 without display unevenness.

FIG. 2 illustrates the liquid crystal display device 1 in which the control substrate 7 is replaced with a new control substrate 7a in a repairing service. The memory 5 is provided on the source substrate 6 as described above, so that the memory 5 is not removed from the liquid crystal display device 1 when the control substrate 7 is replaced. That is, in a case where a service engineer goes to replace the control substrate 7 with a new control substrate 7a, the liquid crystal display device 1 can maintain the intrinsic correction data for correcting the display unevenness without an additional operation which is carried out in the conventional liquid crystal display device, such as detaching the memory 5 from the control substrate 7 and attaching to the new control substrate 7a. Further, the source substrate 6 is bonded to the liquid crystal panel 2 via the source drivers 3, so that the source substrate 6 is not generally replaced on site. It is therefore possible to reduce a workload of a service engineer when replacing and testing the control substrate.

In the present embodiment, there has been described a case where the intrinsic data stored in the memory is correction data for correcting display unevenness generated on the display screen. However, the intrinsic data is not limited thereto as long as the intrinsic data is set to the liquid crystal display device individually, in other words, the intrinsic data storage means for storing data different one to another among the display devices. Examples of the intrinsic data of the memory encompass the following data.

Digital γ correction data

Counter voltage correction data

Serial data for recognizing liquid crystal panel (e.g., panel ID)

Ghost correction data

Tone correction data of a feed-through voltage caused by a feed-through phenomenon

In-plane correction data

Correction data for overshoot driving

The correction data, and the counter voltage correction data for correcting display unevenness have values intrinsic for a certain liquid crystal panel. Meanwhile, the digital γ correction data, the correction data for overshoot driving, etc. are sometimes treated as common data for reducing a time length necessary for preparing the intrinsic data individually, and hence sometimes have both the values intrinsic for the certain liquid crystal panel and values in common with liquid crystal panels (hereinafter referred to as “common data”). In this case, two methods for providing a memory are given as follows:

(1) a method in which a memory, which stores both the intrinsic data and the common data, is provided on a section other than the control substrate; or

(2) a method in which the intrinsic data and the common data are stored in respective memories, and one memory, which stores the intrinsic data, is provided on a section other than the control substrate whereas the other memory (common data storage means), which stores the common data, is provided on the control substrate.

The method of (1) has an advantage of reducing cost of a memory because one common memory stores both the intrinsic data and the common data. On the other hand, although the method of (2) needs two memories, the method of (2) obtains the following advantage by providing on the control substrate the memory for storing the common data.

The digital γ correction data is, for example, a setting data for adjusting a tone and luminescence characteristic of a liquid crystal display device. A γ-characteristic of the digital γ correction data is sometimes changed depending on usage, destination of shipment (market of destination), etc. (e.g., a γ-characteristic is different between liquid crystal display devices for television and for personal computer, and a γ-characteristic is different between liquid crystal display devices for Japan and for Europe) even if each liquid crystal panel does not need to be set individually. When γ-characteristic is different between liquid crystal display devices for television and for personal computer, it is necessary, in a case where the source substrate includes the memory for storing the common data, not only to replace the control substrate but also to rewrite the common data of the memory provided on the source substrate. Meanwhile, when the memory for storing the common data is provided on the control substrate, a γ-characteristic appropriate for the control substrate can be set for the liquid crystal display device only by replacing the control substrate with new control substrate.

Further, an optimum parameter of the correction data of the overshoot driving, which correction data serves as the common data, is changed depending on, for example, a frequency (50 Hz or 60 Hz) of frame rate of the liquid crystal display device. Specifically, the parameter is changed depending on market of destination (an area in which the frequency of 50 Hz is mainly used or an area in which the frequency of 60 Hz is mainly used), or the parameter is increased in the case of producing a liquid crystal display device for a cold district. Also in this case, it is necessary, in a case where the source substrate includes the memory for storing the common data, not only to replace the control substrate but also to rewrite the common data of the memory provided on the source substrate. Accordingly, providing on the control substrate the memory for storing the common data can change the parameter more easily.

As described above, the following two methods are applicable to the present invention: the method in which a memory, which stores both the intrinsic data and the common data, is provided on a section other than the control substrate; or the method in which one memory, which stores the intrinsic data, is provided on a section other than the control substrate whereas the other memory, which stores the common data, is provided on the control substrate.

Further, the present embodiment provides on the source substrate the memory for storing the intrinsic data. However, the present invention is not limited to the source substrate as long as a component is a component which is not replaced as a service. For example, the memory for storing the intrinsic data may be provided on (i) the panel substrate constituting the liquid crystal panel or (ii) the gate substrate on which the gate driver (scanning signal line drive circuit) for driving the gate signal line (scanning signal line) of the liquid crystal panel is provided.

Note that, in a case where the intrinsic data is data read out by the timing controller, such as the correction data for correcting the display unevenness, the memory for storing the intrinsic data is preferably provided on the source substrate. The source substrate is connected to the control substrate, so that wiring for connecting the timing controller and the memory to each other is arranged more easily than a case of providing the memory on any component other than the source substrate.

Further, the memory for storing intrinsic data may be provided on a component, which is a target to be replaced as a service, as long as the component is a component other than the control substrate. The control substrate is frequently replaced on site, whereas the components other than the control substrate are rarely replaced. A power supply substrate, an inverter substrate for backlight, a tuner, etc. are replaceable as a service, however, frequency of replacement of these components is much fewer than that of the control substrate. The present invention makes it possible to reduce a workload of a service engineer more than the conventional arrangement (i.e., the arrangement in which the memory is provided on the control substrate) even if the memory for storing the intrinsic data is provided on a component (which is replaceable as a service) other than the control substrate.

Furthermore, there has been described a case where the liquid crystal display device is repaired on site in the present embodiment. However, the present invention is applicable to a case the liquid crystal display device is repaired in repair shop etc., to thereby reduce a workload of a repairer.

The present invention is not limited to the description of the embodiments above, and may be modified in numerous ways by a skilled person as long as such modification falls within the scope of the claims. An embodiment based on a proper combination of technical means disclosed in different embodiments is encompassed in the technical scope of the present invention.

In the display device according to the present invention, the intrinsic data storage means is preferably provided on a driver substrate on which the drive circuit is provided.

The driver substrate is bonded to the display panel via the drive circuit, so that the driver substrate is not generally replaced on site. It is therefore unnecessary for a repairer to do work on site, such as attachment of the intrinsic data storage means to a replacement component.

In the display device according to the present invention, the intrinsic data storage means is preferably provided on a source substrate on which a data signal line drive circuit for driving a data signal line of the display panel is provided.

In the display device according to the present invention, the intrinsic data storage means is preferably provided on a gate substrate on which a scanning signal line drive circuit for driving a scanning signal line of the display panel is provided.

In the display device according to the present invention, the intrinsic data storage means is preferably provided on a panel substrate constituting the display panel.

The source substrate and the gate substrate are bonded to the display panel via the data signal line drive circuit, so that the source substrate and the gate substrate are not generally replaced on site, and hence the panel substrate is also not replaced on site. Further, the source substrate is connected to the control substrate, so that the timing controller and the intrinsic data storage means are easily connected to each other in a case where the intrinsic data is data read out by the timing controller, such as the correction data for correcting the display unevenness in particular.

In the display device according to the present invention, the intrinsic data may be correction data for correcting display unevenness generated on a display screen of the display penal.

It is preferable that (i) the display device according to the present invention further includes common data storage means for storing common data that is commonly provided to a display device of a same model as that of the display device and (ii) the data storage means is provided on the control substrate.

The display device according to the present invention may be a liquid crystal display device.

### INDUSTRIAL APPLICABILITY

The present invention is suitably applicable to a liquid crystal display device which is a target to be repaired on site by a service engineer in particular. The present invention is applicable to, for example, a liquid crystal television for home use, a liquid crystal display for personal computer, and electrical appliances including liquid crystal display screens, such as an air conditioner and a refrigerator. Further, the present invention is also applicable to a display device such as an electroluminescence display.

### REFERENCE SIGNS LIST

1 liquid crystal display device (display device)

2 liquid crystal panel (display panel)

3 source driver (drive circuit, data signal line drive circuit)

4 timing controller

5 memory (intrinsic data storage means)

6 source substrate (driver substrate)

7 control circuit

7a control circuit

1. A display device, comprising:
a display panel;
a drive circuit for driving the display panel;
a timing controller for supplying a timing control signal to the drive circuit; and
intrinsic data storage means for storing intrinsic data that is set to the display device individually,
wherein the intrinsic data storage means is provided on a section other than a control substrate on which the timing controller is provided.

2. The display device as set forth in claim 1, wherein the intrinsic data storage means is provided on a driver substrate on which the drive circuit is provided.

3. The display device as set forth in claim 2, wherein the intrinsic data storage means is provided on a source substrate on which a data signal line drive circuit for driving a data signal line of the display panel is provided.

4. The display device as set forth in claim 2, wherein the intrinsic data storage means is provided on a gate substrate on which a scanning signal line drive circuit for driving a scanning signal line of the display panel is provided.

5. The display device as set forth in claim 1, wherein the intrinsic data storage means is provided on a panel substrate included in the display panel.

6. The display device as set forth in claim 1, wherein the intrinsic data is correction data for correcting display unevenness generated on a display screen of the display penal.

7. The display device as set forth in claim 1, further comprising common data storage means for storing common data that is commonly provided to display devices of a same model as that of the display device,
wherein the data storage means is provided on the control substrate.

8. The display device as set forth in claim 1 wherein the display device is a liquid crystal display device.
